(19) United States
(12) Patent Application Publication
(10) Pub. No.: US 2006/0081344 A1
(43) Pub. Date: Apr. 20, 2006

(54) Portable blackout shade

(76) Inventor: Diana McKearney, Needham, MA (US)

Correspondence Address: DITTHAVONG & CARLSON, P.C., Suite A, 10507 Braddock Rd, Fairfax, VA, 22032, US

(21) Appl. No.: 11/243,592

(22) Filed: Oct. 5, 2005

Related U.S. Application Data
(60) Provisional application No. 60/615,588, filed on Oct. 5, 2004.

(51) Int. Cl. E06B 9/00

(52) U.S. Cl. 160/368.1

(57) ABSTRACT

A shade used to cover a window opening or the like is made of opaque material with fastening means adhered to the back of the material. The shade can be hung on the window using a hook and loop type fastener or a double-sided removable adhesive that is mounted on the window frame or the wall surrounding the window.

### RELATED APPLICATIONS

This application is related to, and claims the benefit of the earlier filing date under 35 U.S.C. § 119(e) of, U.S. Provisional Patent Application (Ser. No. 60/615,588; Attorney Docket 01056-1000), filed Oct. 5, 2004, entitled “Travel Blackout Shade”; the entirety of which is incorporated herein by reference.

### FIELD OF THE INVENTION

The present invention relates to window treatments and more particularly to a blackout shade suitable for temporary or portable use.

### BACKGROUND OF THE INVENTION

Parents with young children are fully aware how difficult it can sometimes be to travel to visit friends and relatives, and a major factor determining whether an overnight visit will be pleasant for everyone involved is whether those traveling are able to sleep restfully. For example, nap time is critical for young children to rejuvenate themselves both emotionally and physically, and the parents of napping children often need that time to attend to various needs and errands. Moreover, a good night's sleep is often vital for both the parents and the children to be at their best when staying with others. The importance of restful sleep on the road is not limited to young children and those traveling with them-business men and women may have early-morning presentations at which it is important to be at their best.

Many children, however, and even some adults find it difficult to sleep in unfamiliar surroundings or in rooms where the light from the outside is not adequately blocked. Light coming in a window at bedtime may prevent some people from being able to get to sleep and light coming in a window at dawn may wake some people prematurely. Some people also find it difficult to take naps or sleep during the daytime if they are aware that there is a sunny day outside. This stems from the fact that melatonin, which is a natural hormone that aids sleep, is suppressed with daylight.

Hotels are generally aware of the importance of being able to sleep well out of town, and they may provide blackout curtains, for example, which are heavy and opaque to block passage of most of the ambient outside light. These curtains can become misaligned and permit too much light to pass into the hotel room. The problem can be even more critical in private homes, because those homes do not usually have blackout curtains.

Various temporary window shades have been developed but they are unsuitable for the specific needs of travelers, and especially those traveling with young children to private homes. For example, U.S. Pat. No. 5,025,848 to Prochaska describes a temporary window shade that is designed to cover a window opening during the period when a person is awaiting the arrival and installation of a permanent window covering. According to this reference, the shade is made of a disposable, translucent material that must be cut to fit a particular window and affixed to or near a window frame. This product is designed to be an interim measure, and it is not so suitable for those visiting other people's homes who are faced with having to accommodate existing window treatments. For example, private home owners and hotels are generally not willing to detach their window treatments or otherwise permit their windows and walls to be marred, and it may be difficult to work around the existing window treatments to measure, fit, and apply the translucent material accurately. In addition, the temporary window shades cannot be folded or otherwise reduced to a small size for travel nor are they designed to be reused.

Therefore, there is a need for a window shade that addresses the specific problems associated with portability and temporary use, especially for those with young children visiting friends and relatives.

### SUMMARY OF THE INVENTION

The present invention address this and other needs with a portable blackout shade that is sized to cover not only a window opening but also, if needed, any window treatments that also cover the window. The portable blackout shade is made of an opaque material. The shade can be hung on the window using a double-sided adhesive that is removably attached to the shade and then mounted on the window frame or the wall surrounding the window. By being sized to cover existing window treatments, the portable shade can therefore accommodate a wide variety of different types of windows, curtains, shades, and blinds that are already present but are ineffective for providing a suitable environment for young children and even adults to fall asleep. The shade can also be used to cover odd shaped windows and skylights. Also, such a blackout shade need not contain any stiff or inflexible metal or plastic parts, thereby making it easier to fold and place in a suitcase for ease of portability (e.g., travel).

Furthermore, a decorative fabric can be put on the front of the material to provide a continuity of decor that is comforting to a child. Many children have sleep associations in which they find it difficult to go to sleep without their favorite teddy bear, blanket, or doll. Some of these children may associate the right conditions for falling asleep with being able to see a picture of their favorite cartoon character on the wall near their bed with a nightlight. In this embodiment of the present invention, the decorative fabric can advantageously maintain that sleep association to help the child fall asleep more easily by allowing that comforting character to be present in the room.

Accordingly, one aspect of the present invention relates to a portable blackout shade that comprises a flexible, opaque material sized to cover an opening in an architectural structure that permits passage of visible light (such as a window, a door, or a porthole) and sized to cover a fixture affixed to the architectural structure that has at least one configuration that blocks passage of at least half of the visible light from the opening (such as a curtain, shade, blinds, or a window treatment that protrudes from a wall near the opening).

In an embodiment of the present invention, strips of a double-sided removable adhesive are adhered to a common side of the material and can be removably adhered to the architectural structure, wherein substantially all of said visible light from the opening is blocked.

In an embodiment of the present invention, strips of one half of a two-part fastener, which are removably attachable to their corresponding halves, such as a hook-and-loop-type fastener, are utilized. The corresponding halves of the fasteners when the first parts of the two-part fasteners are attached to the second parts.

In an embodiment of the present invention, the shade can be folded to cover an area smaller than the opening, for example, to conveniently fit within a suitcase or to partially raise the shade to permit some light to pass through. For the latter purpose, additional two-part fasteners can be adhered to the opposite side of the material and arranged to be removably attached to allow the opaque material to be folded similar to a Roman shade.

In one embodiment of the present invention, the portable blackout shade can also include a decorative fabric that is fixed to a side of the flexible, opaque material.

Another aspect of the present invention involves a travel kit that includes such a portable blackout shade and either of the following arrangements is utilized: (i) corresponding halves of a two-part fastener, and an adhesive for removably adhering the corresponding halves to an architectural structure such that substantially all of the visible light from the opening is blocked when halves of the two-part fasteners are attached to each of other, or (ii) strips of double-sided adhesive for removably adhering the shade to the architectural structure. The adhesive may include a non-marring adhesive, putty, or other material that can be removed from the architectural structure without leaving a residue, destroying the paint or wallpaper, or other noticeably affecting the appearance of the structure after removal.

Yet another aspect of the present invention pertains to a method for installing such a blackout shade by: adhering the corresponding halves of the two-part fastener to the architectural structure and attaching the other halves of the two-part fasteners adhered to the opaque material to them, such that substantially all of the visible light from the opening is blocked and the parts of the fasteners can be detached and reattached; or adhering a double-sided removable adhesive to the opaque material and to the architectural structure, such that substantially all of the visible light from the opening is blocked.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a view of the front of a conventional window showing one embodiment of a portable blackout shade in the installed position.

FIG. 2 is a front view of the back of the portable blackout shade, according to one embodiment of the present invention.

FIG. 3 is a front view of the front of the portable blackout shade, according to one embodiment of the present invention.

FIG. 4 s a front view of the front of the portable blackout shade in a partially raised position, according to one embodiment of the present invention.

FIG. 5 is a front view of the portable blackout shade in a fully raised position, according to one embodiment of the present invention.

FIG. 6 is a side view of the portable shade in a raised position, according to one embodiment of the present invention.

### DESCRIPTION OF THE PREFERRED EMBODIMENT

A blackout shade, a travel kit for a blackout shade, and a method of installing a blackout shade are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

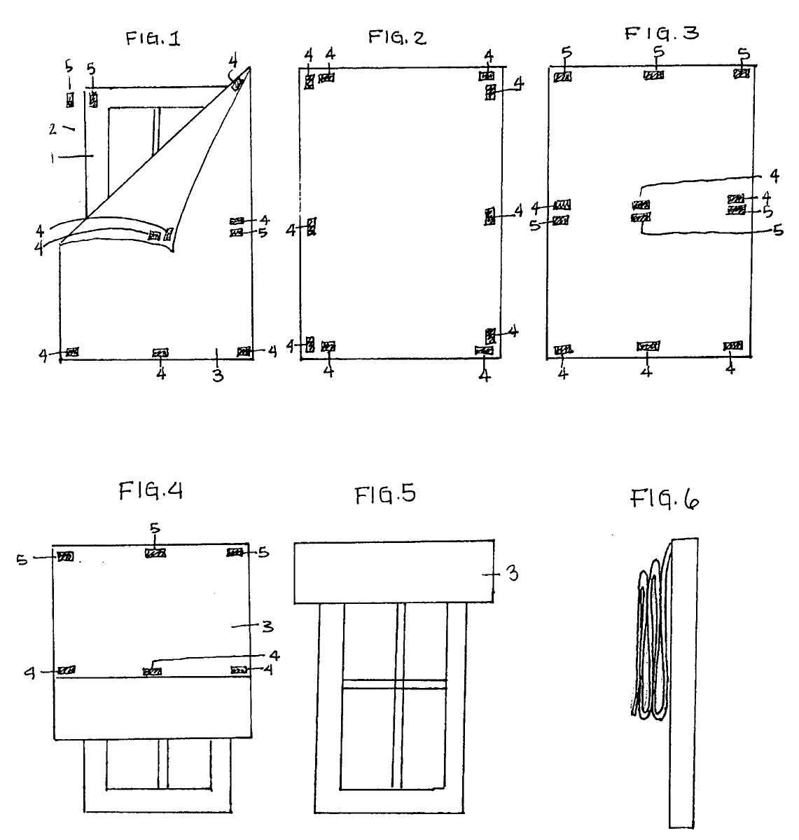

FIG. 1 depicts a portable blackout shade sized to cover a window or other type of opening in an architecture structure that permits the passage of visible light. The blackout shade may be attached to a window frame 1 or the wall 2 around the window if the window is encumbered by a window treatment such as a curtain, blinds, shade, or other fixture affixed to or protruding from the wall that can be configured to block the passage of at least some (such as half) of the outside light.

The portable blackout shade includes a light-blocking material 3 that can be both flexible and opaque, made of, for example, one or more layers of woven fabrics and/or plastic, acrylic or other laminations.

In an embodiment of the present invention, a piece of decorative fabric can be sewn, glued, or otherwise fused to the light-blocking material. Alternatively, the decoration may be printed directly on the blackout fabric using sublimation, heat transfer or other means of printing. The decor of the decorative fabric can be designed to resemble the decor of a child's bedroom or a familiar character or pattern and thereby advantageously maintain the child's sleep association to fall asleep more easily.

Various fastening mechanisms can be utilized to secure or affix the shade to the fixture, window frame, wall, etc. Exemplary fastening mechanisms include two-part fasteners and double-sided adhesive strips, as described below. Adhered to the back side of the material 3 is one half 4 of two-part fastener system, such as loop part of a hook-and-loop-type fastener, as by sewing, gluing, or other such means. Other two-part fastener may include snaps, buttons, or other types of interlocking fasteners.

The corresponding halves of the two-part fastener, e.g. the hook part 5, can be applied with adhesive and attached to either the window frame 1 or the wall 2 around the window and over an existing window treatment as shown in FIG. 1. The adhesive can be a non-marring adhesive that can be removed from the window frame 1 or wall 2 around the window without leaving a residue, destroying the paint or wall paper, or otherwise noticeably affecting the appearance of the structure after removal. Alternatively, a double-sided adhesive can be applied directly to the opaque material and to the window frame 1 or the wall 2 around the window.

FIG. 2 shows one arrangement of the loop parts 4 of the two-part fastener system that allows a negligible amount of leakage of visible light around the edges of the blackout shade and/or provides a firm attachment to the window frame 1 or the wall 2 around the window. For example, the loop parts 4 may be positioned near the edges of the material 3 at the corners and the middles.

In an embodiment of the present invention, the front of the portable blackout shade may have additional hook and loop type fasteners 4, 5 on the front of the portable blackout shade as shown in FIG. 3. Thus, the shade can be folded on itself to engage the corresponding halves of the fasteners 4, 5 and placed into a partially raised position as shown in FIG. 4 or a fully raised position as shown in FIG. 5. FIG. 6 is a side view of the fully raised position, showing how the material 3 can be folded like a Roman shade.

Accordingly, a portable travel shade is described that is easy to hang and to remove, reusable, usable directly over existing window treatments, and folds up compactly for travel.

While the present invention has been described in connection with a number of embodiments and implementations, the present invention is not so limited but covers various obvious modifications and equivalent arrangements, which fall within the purview of the appended claims.

What is claimed is:

1. A portable blackout shade, comprising:
a flexible, opaque material sized to cover an opening in an architectural structure that permits passage of visible light and sized to cover a fixture affixed to the architectural structure that has at least one configuration that blocks passage of at least half of the visible light from the opening; and
a fastening mechanism configured to secure the flexible, opaque material, the fastening mechanism including either,
a plurality of two-part fasteners having respective first parts adhered to the flexible, opaque material at respective positions of a common side of the opaque material and removably attachable to corresponding respective second parts, or
a plurality of double-sided adhesive strips that are removably attachable to the opaque material and a window frame or wall surrounding the architectural opening.

2. The portable blackout shade of claim 1, wherein the opening in the architectural structure includes a window, a door, or a porthole, and the fixture affixed to the architectural structure includes a curtain, blinds, a shade, or window treatment protruding from the architectural structure.

3. The portable blackout shade of claim 1, further comprising the second parts of the two-part fasteners.

4. The portable blackout shade of claim 1, wherein the second parts of the two-part fasteners are removably adhered to the architectural structure, wherein substantially all of said visible light from the opening is blocked when the first parts of the two-part fasteners are attached to the second parts.

5. The portable blackout shade of claim 1, wherein the two-part fasteners includes a hook-and-loop fastener.

6. The portable blackout shade of claim 1,-wherein the shade is capable of being folded to cover an area smaller than the opening.

7. The portable blackout shade of claim 1, further comprising:
at least one other two-part fastener having a first part adhered to an opposite side of the opaque material and a second part adhered to said opposite side.

8. The portable blackout shade of claim 7, wherein said first part is arranged to be removably attached to said second part when the flexible, opaque material is folded and to permit passage of at least half of the visible light permitted by the fixture to pass through the opening.

9. The portable blackout shade of claim 1, further comprising a decorative fabric fixed to a side of the flexible, opaque material.

10. A travel kit, comprising:
a blackout shade comprising a flexible, opaque material sized to cover an opening in an architectural structure that permits passage of visible light and sized to cover a fixture affixed to the architectural structure that has at least one configuration that blocks passage of at least half of the visible light from the opening, and a fastening means for securing the flexible, opaque material, the fastening means including either,
a plurality of two-part fasteners having respective first parts adhered to the flexible, opaque material at respective positions of a common side of the opaque material and removably attachable to corresponding respective second parts, or
a plurality of double-sided adhesive strips that are removably attachable to the opaque material and a window frame or wall surrounding the architectural opening;
the second parts of the two-part fasteners, if the fastening means is the two-part fasteners; and
if the fastening means is the two-part fasteners, an adhesive for removably adhering the second parts of the two-part fasteners to the architectural structure, wherein substantially all of said visible light from the opening is blocked when the first parts of the two-part fasteners are attached to the second parts.

11. The travel kit according to claim 10, wherein the opening in the architectural structure includes a window, a door, or a porthole, and the fixture affixed to the architectural structure includes a curtain, blinds, a shade, or window treatment protruding from the architectural structure.

12. The travel kit according to claim 10, wherein the adhesive comprises a non-marring adhesive.

13. A method for installing a shade, comprising:
providing a blackout shade comprising a flexible, opaque material sized to cover an opening in an architectural structure that permits passage of visible light and sized to cover a fixture affixed to the architectural structure that has at least one configuration that blocks passage of at least half of the visible light from the opening and a fastening mechanism configured to secure the flexible, opaque material, the fastening mechanism including either,
a plurality of two-part fasteners having respective first parts adhered to the flexible, opaque material at respective positions of a common side of the opaque material and removably attachable to corresponding respective second parts, or
a plurality of double-sided adhesive strips that are removably attachable to the opaque material and a window frame or wall surrounding the architectural opening;
if the fastening mechanism includes the two-part fasteners, adhering the respective second parts of the two-part fasteners to the architectural structure; and
if the fastening mechanism includes the two-part fasteners, attaching the respective first parts of the two-part fasteners to the corresponding respective second parts, whereby substantially all of said visible light from the opening is blocked.

14. The method of claim 13, wherein the opening in the architectural structure includes a window, a door, or a porthole, and the fixture affixed to the architectural structure includes a curtain, blinds, a shade, or window treatment protruding from the architectural structure.

15. The method of claim 13, further comprising detaching the respective first parts of the two-part fasteners from the corresponding respective second parts and reattaching the respective first parts of the two-part fasteners to the corresponding respective second parts.

16. The method of claim 13, further comprising removing the respective first second parts from the architectural structure without noticeably affecting an appearance of the architectural structure; and re-adhering the respective first second parts to another architectural structure.

17. The method of claim 13, further comprising folding the blackout shade to cover an area smaller than the opening.
